(19) United States
(12) Patent Application Publication
(10) Pub. No.: US 2009/0071901 A1
(43) Pub. Date: Mar. 19, 2009

(54) SYSTEM AND METHOD FOR FILTERING LIQUIDS

(76) Inventor: Hamid R. Rabie, Mississauga (CA)

Correspondence Address: HERMAN & MILLMAN, 141 ADELAIDE ST. WEST, SUITE 1002, TORONTO, ON, M5H 3L5, CA

(21) Appl. No.: 12/133,926

(22) Filed: Jun. 5, 2008

Related U.S. Application Data
(60) Provisional application No. 60/973,599, filed on Sep. 19, 2007.
(60) Provisional application No. 60/973,802, filed on Sep. 20, 2007.

(51) Int. Cl. B01D 65/02; C02F 1/44; B01D 35/16

(52) U.S. Cl. 210/636; 210/106; 210/739

(57) ABSTRACT

In one aspect, the invention is directed to methods and systems for filtering water using membranes. The methods and systems provide for controlling water levels in a tank with membranes immersed therein to control any of various conditions in the tank, such as the gas flow from aerators in the tank, the level of circulation of water in the tank, and the residence time of bubbles in the tank.

### FIELD OF THE INVENTION

The invention relates to filtering liquids using membranes and more particularly to using air bubbles to clean or inhibit fouling of membranes in a submerged membrane filter.

### BACKGROUND OF THE INVENTION

Some types of membrane filtration systems operate using one or more membrane modules immersed in a tank of water that contains solids to be removed. The membrane modules typically require some form of cleaning or preventive action in order to inhibit them from fouling with solids on their exterior surfaces. A technology that is in use today for that purpose is aeration. Aeration involves the release of gas from aerators positioned in the water tank beneath the membranes. The gas typically leaves the aerators in the form of bubbles which interact with the membranes and remove solids that accumulate on the membranes.

The cost effectiveness of using aeration is related in part to the amount of gas used, for several reasons. Relatively high gas flows typically require relatively large blowers to provide the gas, which brings an associated large energy cost. Additionally, high gas flows in the water can result in increased stresses on the membranes and on their connections to permeate collection headers which transport collected permeate away from the system. The increased stresses can result in premature failure of the membranes or connections, leading to increased costs for maintenance and repair.

While it is advantageous to use aeration to clean membranes and/or inhibit their fouling with solids, it is desirable to provide new methods and systems to reduce the costs associated with that technology.

### SUMMARY OF THE INVENTION

In one aspect, the invention is directed to methods and systems for filtering water using membranes. The methods and systems provide for controlling water levels in a tank with membranes immersed therein to control any of various conditions in the tank, such as the gas flow from aerators in the tank and the level of circulation of water in the tank, and the residence time of bubbles in the tank, all of which serve to control the flow of bubbles in the tank.

In a particular embodiment, the invention is directed to a method of aerating at least one membrane module immersed in water in a tank, comprising:

providing a flow of gas to at least one aerator to produce a flow of bubbles in the tank for cleaning or inhibiting fouling of the at least one membrane module; and

adjusting the level of the water in the tank to control the flow of bubbles from the at least one aerator.

In another particular embodiment, the invention is directed to a system for aerating at least one membrane module immersed in water in a tank, comprising:

at least one aerator positioned for releasing gas bubbles into the water to clean or inhibit fouling of the at least one membrane module;

a feedwater conduit for introducing water to the tank;

a drain conduit for removing water from the tank;

a control valve positioned to control the flow of water through at least one of the feedwater conduit and the drain conduit; and

a control system operatively connected to the control valve, wherein the control system is configured to control the control valve to adjust the level of the water in the tank to control at least one of: the flow of bubbles in the tank, the circulation of water in the tank, and the level of water in the at least one aerator.

In another particular embodiment, the invention is directed to a method of aerating at least one membrane module immersed in water in a tank, comprising:

providing a flow of gas to at least one aerator to produce a flow of bubbles in the tank for cleaning or inhibiting fouling of the at least one membrane module; and

controlling the water level in the tank between a high water level and a low water level to control the degree of circulation of water in the tank resulting from the flow of bubbles leaving the at least one aerator.

In another aspect, the present invention is directed to a method and system that achieves aeration of membranes immersed in water, while reducing the energy costs associated with such aeration. Two (or more) tanks with membranes immersed therein are fed from a common gas supply device. The water level is individually controlled in each tank, which controls the aeration gas flow into each of the tanks.

In a particular embodiment, the water level is adjusted so that in one stage it is higher in a first tank and lower in a second tank, preferentially sending aeration gas to the second tank. In another stage the water level is lower in the first tank and higher in the second tank preferentially sending aeration gas to the first tank.

In another particular embodiment, the invention is directed to a method of aerating a first membrane module immersed in water in a first tank and a second membrane module in a second tank, comprising:

providing a first aerator to produce bubbles in the first tank for cleaning or inhibiting fouling of the first membrane module;

providing a second aerator to produce bubbles in the second tank for cleaning or inhibiting fouling of the second membrane module;

fluidically connecting the first and second aerators to a common gas source;

controlling the water level in each of the first and second tanks between a high water level and a low water level, in a cycle including a first stage wherein the water level in the first tank is at the high water level and the water level in the second tank is at the low water level so that backpressure in the first aerator urges gas flow from the common source to preferentially travel to the second aerator, and a second stage wherein the water level in the first tank is at the low water level and the water level in the second tank is at the high water level so that backpressure in the second aerator urges gas flow from the common source to preferentially travel to the first aerator.

In another particular embodiment, the invention is directed to a system for aerating a first membrane module immersed in water in a first tank and a second membrane module in a second tank, comprising:

a first aerator positioned to produce bubbles in the first tank for cleaning or inhibiting fouling of the first membrane module;

a second aerator positioned to produce bubbles in the second tank for cleaning or inhibiting fouling of the second membrane module;

a common gas source fluidically connected to the first and second aerators; and

a control system for controlling the water level in the first and second tanks, wherein the control system is configured to hold the water level in each of the tanks in successive stages including a first stage wherein the water level in the first tank is at the high water level and the water level in the second tank is at the low water level so that backpressure in the first aerator urges gas flow from the common source to preferentially travel to the second aerator, and a second stage wherein the water level in the first tank is at the low water level and the water level in the second tank is at the high water level so that backpressure in the second aerator urges gas flow from the common source to preferentially travel to the first aerator.

In another particular embodiment, the invention is directed to a method of aerating at least one membrane module immersed in water in a tank, comprising:

providing a flow of gas to at least one aerator to produce a flow of bubbles in the tank for cleaning or inhibiting fouling of the at least one membrane module; and

controlling the water level in the tank between a high water level, an intermediate water level and a low water level to control the degree of circulation of water in the tank and to control the flow of bubbles from the at least one aerator,

wherein at the low water level, the flow rate of gas leaving the at least one aerator is a first flow rate and circulation in the tank is inhibited as a result of the low water level,

and wherein at the high water level the flow rate of gas leaving the at least one aerator is a second flow rate that is lower than the first flow rate and circulation in the tank is permitted as a result of the high water level,

and wherein at the intermediate water level, the flow rate of gas leaving the at least one aerator is a third flow rate that is not lower than the second flow rate and not higher than the first flow rate and circulation in the tank is permitted as a result of the intermediate water level.

In another aspect, the invention is directed to a method and system for cleaning an aerator that is immersed in the tank of a membrane filtration system. The method entails controlling the water pressure outside of the aerator to control the pressure differential between gas supplied to the aerator and the water surrounding the aerator. By adjusting the water pressure outside the aerator to a higher pressure, water enters the aerator. By adjusting the water pressure outside the aerator to a lower pressure, water that is in the aerator is pushed out of the aerator by the gas supplied to the aerator.

In another particular embodiment, the invention is directed to a method of cleaning or inhibiting fouling of an aerator that is immersed in water in a tank for aerating at least one membrane module, comprising:

controlling the pressure in the water in the tank at surrounding the at least one aerator between a high pressure and a lower pressure, wherein at the higher pressure, the at least one aerator fills at least partially with water, and wherein at the lower pressure, the gas pressure from the gas supplied to the at least one aerator overcomes the lower pressure in the surrounding water and thereby empties the at least one aerator at least partially of water.

In another particular embodiment, the invention is directed to a method of cleaning or inhibiting fouling of an aerator that is immersed in water in a tank for aerating at least one membrane module, comprising:

controlling the water level in the tank between a high water level and a low water level, wherein at the high water level, the at least one aerator fills at least partially with water, and wherein at the low water level, gas pressure in the at least one aerator overcomes the water pressure outside the at least one aerator and empties at least partially of water.

In another particular embodiment, the invention is directed to a system for aerating at least one membrane module immersed in water in a tank, comprising:

at least one aerator positioned for releasing gas bubbles into the water to clean or inhibit fouling of the at least one membrane module;

a feedwater conduit for introducing water to the tank;

a drain conduit for removing water from the tank;

a control valve positioned to control the flow of water through at least one of the feedwater conduit and the drain conduit; and

a control system operatively connected to the control valve, wherein the control system is configured to control the control valve to adjust the level of the water in the tank to control the water pressure outside the aerator, thereby controlling the flow of water into and out of the aerator.

### BRIEF DESCRIPTION OF THE DRAWINGS

For a better understanding of the present invention, and to show more clearly how it may be carried into effect, reference will now be made, by way of example, to the accompanying drawings in which:

FIG. 1 is an elevation view of a membrane filtration system in accordance with an aspect of the present invention;

FIG. 2 is a magnified sectional view of a membrane used in the membrane filtration system shown in FIG. 1;

FIG. 3 is a magnified perspective view of an aerator used in the membrane filtration system shown in FIG. 1;

FIG. 4a is an elevation view of the membrane filtration system shown in FIG. 1, with the water level at an intermediate level, with some structure removed for clarity;

FIG. 4b is an elevation view of the membrane filtration system shown in FIG. 1, with the water level at a low level, with some structure removed for clarity;

FIG. 4c is an elevation view of the membrane filtration system shown in FIG. 1, with the water level at a high level, with some structure removed for clarity;

FIG. 5 is a graph of gas flow rate from the aerators over time;

FIG. 6 is a plan view of a membrane filtration system with two tanks in accordance with another aspect of the present invention;

FIG. 7a is an elevation view of the membrane filtration system shown in FIG. 6, in a first state with respect to the water levels in the two tanks, with some structure removed for clarity;

FIG. 7b is an elevation view of the membrane filtration system shown in FIG. 6, in a second state with respect to the water levels in the two tanks, with some structure removed for clarity;

FIG. 7c is an elevation view of the membrane filtration system shown in FIG. 6, in a third state with respect to the water levels in the two tanks, with some structure removed for clarity; and

FIG. 8 is a graph of gas flow rate from the aerators in the two tanks over time.

### DETAILED DESCRIPTION OF THE INVENTION

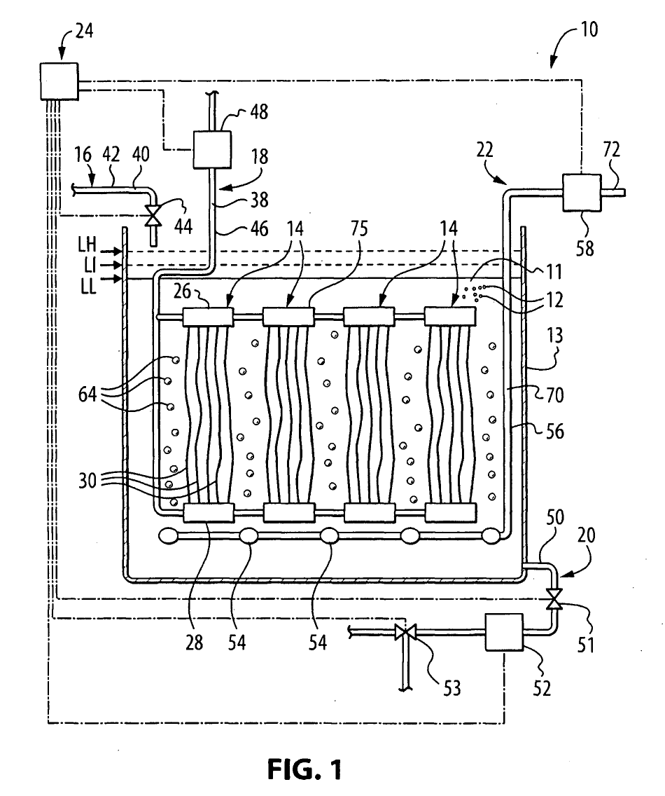

Reference is made to FIG. 1, which shows a membrane filtration system 10 for use in filtering a liquid such as water 11 to remove impurities 12 such as particulate matter and microorganisms (which will hereinafter be referred to cumulatively as solids 12). The membrane filtration system 10 includes a tank 13, a plurality of membrane modules 14, a feedwater supply system 16, a permeate collection system 18, a drain system 20, an aeration system 22 and a control system 24. The tank 13 is configured to hold water 11 containing solids 12, preferably at ambient pressure. In other words, any air above the water 11 is preferably at ambient pressure.

It will be understood that the term ‘water’ is not intended to be limited to mean pure water, and that, aside from solids 12, the water 11 may contain numerous other non-solid components, such as dissolved salts. In FIG. 1, only a small area of the water 11 is shown as containing solids 12, so as to maintain clarity of the drawing. It will, however, be understood that solids 12 will be present throughout the volume of water 11 in the tank 13. The solids 12 that are present in the water 11 may be within a broad spectrum of size ranges. For example, some or all of the solids 12 may be sub-micron in size. Additionally or alternatively, some or all of the solids 12 may be on the order of several microns in size. Additionally or alternatively, some or all of the solids 12 may be several millimeters in size. It will also be understood that the solids 12 that are shown in FIG. 1 are greatly exaggerated in size for the purpose of clarity of the drawing.

A plurality of membrane modules 14 are immersed in the tank 13. The membrane modules 14 may be configured in any suitable way. For example, each membrane module 14 may include a first permeate header 26, a second permeate header 28 and a plurality generally tubular membranes 30 that extend between the first and second permeate headers 26 and 28. In the configuration shown in FIG. 1, the membrane module 14 is oriented vertically in the sense that the first permeate header 26 is an upper permeate header, the second permeate header is a lower permeate header and the membranes 30 extend generally vertically between them. It will be understood that the membrane module 14 could alternatively have other suitable orientations, such as an orientation wherein the membranes extend generally horizontally and the first and second permeate headers 26 and 28 are horizontally spaced from each other.

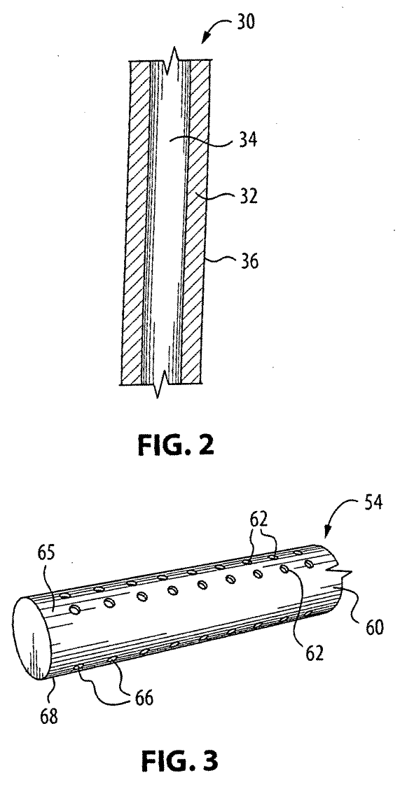

The membranes 30 may be any suitable types of membranes, such as hollow fibre membranes, flat sheets, spiral wound, tubular or other suitable configurations. Referring to FIG. 2 which shows an exemplary embodiment that is a hollow fibre membrane 30, each membrane 30 may have a membrane wall 32 and a lumen 34. The outer surface of the membrane 30 is shown at 36. The lumen 34 may be referred to as the clean side of the membrane 30 as this is the side of the membrane 30 that will see permeate, shown at 38 in FIG. 1. The outer surface 36 of the membrane 30 may also be referred to as the dirty side of the membrane 30 as this is the side of the membrane 30 that is exposed to tank water 11.

The membranes 30 may be made from any suitable material so as to achieve any suitable level of filtration, such as, for example, microfiltration, ultrafiltration or nanofiltration.

The membranes 30 may be supported, or unsupported. A supported membrane 30 denotes a membrane that incorporates a means for increasing its mechanical strength, such as a braided wire mesh (not shown), within the membrane wall 32. Supporting a membrane 30 assists the membrane 30 in withstanding the pressure differential across the membrane wall 32 during use, and also improves the ability of the membrane 30 to resist other types of stresses. Other means for supporting the membrane 30 include, for example, an inner or outer reinforcement layer that has a sufficiently open structure so as not to unduly interfere with the permeation of water through the membrane wall 32. Such a reinforcement layer may be provided from any suitable material, such as a woven or a non-woven material.

Referring to FIG. 1, the first and second permeate headers 26 and 28 are used to collect permeate that passes through the membrane walls 32 (FIG. 2) into the lumens 34 of the membranes 30. The membranes 30 may be mounted to the permeate headers 26 and 28 in any suitable way to permit fluid communication between the lumen 34 (FIG. 2) and the interiors of the permeate headers 26 and 28 (FIG. 1). The process by which the membranes 30 filter the water 11 to collect the permeate 38 may be, for example, by means of a pressure differential across the membrane wall 32 (FIG. 2). In embodiments, such as the embodiment shown in FIG. 1 where the tank 13 is open to atmosphere, the pressure differential may be improved by drawing a partial vacuum in the lumen 34 (FIG. 2) of the membrane 30.

As shown in FIG. 1, the membranes 30 may have some amount of slackness in them, ie. they are not tautly held between the first and second permeate headers 26 and 28. Such slackness permits the membranes 30 to be more effectively cleaned and to more effectively inhibit fouling during aeration by the aeration system 22, as compared to a membrane module that had an equivalent membrane density, but with tautly held cables.

In FIG. 1, there are four membrane modules 14 shown. It is possible however, for there to be more or fewer membrane modules 14 in the tank 13. For example, there could be as few as one membrane module 14 in the tank 13.

The feedwater supply system 16 supplies feedwater, shown at 40, to the tank 13. The feedwater supply system 16 includes a feedwater supply conduit 42 and, optionally, a feedwater supply control valve 44. The feedwater supply control valve 44 controls the flow of feedwater 40 out of the feedwater supply conduit 42 into the tank 13. The feedwater supply control valve 44 may be an automated control valve that is controlled by any suitable means, such as by the control system 24. The feedwater supply control valve 44 may be any suitable type of valve, and may optionally be capable of controlling flow over a continuous range, or may alternatively be capable only of movement to discrete positions, such as an open position and a closed position, to control flow.

The permeate collection system 18 may include any suitable structure, such as, for example, a conduit system 46 configured to receive permeate from the permeate headers 26 and 28 from all the membrane modules 14, and a pump 48. The pump 48 may be controlled by any suitable means, such as by the control system 24.

The drain system 20 is used to remove concentrate 49 from the tank 13. The drain system 20 includes a drain conduit system 50, a drain system control valve 51, a drain system pump 52 and a drain system concentrate diverter valve 53. The drain system control valve 51 may be any suitable type of valve, and may optionally be an automated valve that is controlled by the control system 24. The drain system control valve 51 may be capable of controlling flow of concentrate 49 over a continuous range of flows, or may alternatively be capable only of movement to discrete positions, such as an open position and a closed position, to control flow.

In the embodiment shown in FIG. 1, there is only one drain conduit 50 shown, however, it is optionally possible for there to be a plurality of drain conduits 50 shown that draw concentrate 49 from different locations within the tank 13. Preferably, in embodiments wherein there are two or more drain conduits 50 provided, the drain conduits 50 all combine flows into a common drain conduit, which has the drain system control valve 51 thereon. In this way, the cost of individual drain system control valves 51 on all the drain conduits 50 is avoided.

The drain system pump 52 is used to pump the concentrate 49 away from the tank 13. The diverter valve 53 is positionable to send concentrate either out of the membrane filtration system 10, or back to the feedwater supply conduit 42 upstream from the feedwater control valve 44, depending on the position of the diverter valve 53. The diverter valve 53 may be configured so that it permits adjustment to control the percentage of the concentrate flow that is sent out of the system 10 and consequently the percentage of the concentrate flow that is sent back to the feedwater supply conduit 42. It will be understood that the recirculation of concentrate back into the tank 101 is an optional feature. It will also be understood that the drain conduit 50 need not join back into the feedwater supply conduit 42, but could alternatively be routed to feed the tank 13 separately from the feedwater supply system 16.

The aeration system 22 provides aeration of the membranes 30 in the tank 13 so as to clean the membranes 30 or to inhibit fouling of the membranes 30 during use. The aeration system 22 includes a plurality of aerators 54, an aeration system conduit system 56 and gas supply device 58. Referring to FIG. 3, each aerator 54 has an aerator body 60, which may simply be a section of conduit, and which has a plurality of aeration apertures 62. The aeration apertures 62 may be sized so that gas leaving the aerators 54 leaves in the form of bubbles, shown at 64, having a size that is generally within a selected range. The bubbles 64 interact with the outer surfaces 36 (FIG. 2) of the membranes 30 so as to provide the aforementioned action of cleaning and/or inhibiting the fouling of the membrane outer surface 36.

The aeration apertures 64 may be positioned anywhere suitable on the aerator body 60, such as on its upwards facing surface, shown at 65.

Each aerator 54 may also include a plurality of purge apertures 66 along its underside, which is shown at 68. The purge apertures 66 are described in further detail further below.

The gas supply device 58 may be any suitable type of device for supply gas, shown at 70, at a selected pressure. For example, the gas supply device 58 may be a blower. The gas 70 that is provided by the gas supply device 58 may simply be ambient air drawn through a gas inlet 72 from the environment in which the membrane filtration system 10 is installed. Alternatively, the gas 70 may have some other composition. For example, the gas 70 may comprise essentially ambient air, but may have its composition adjusted in any suitable way. For example, the gas 70 may comprise oxygen enriched ambient air.

Referring to FIG. 1, the control system 24 may be configured to control, among other things, all or a portion of the operation of the aeration system 22. The control system 24 preferably includes hardware programmed with suitable control software.

The control system 24 may be used to control the water level in the tank 13 between a low level LL, an intermediate level LI and a high level LH.

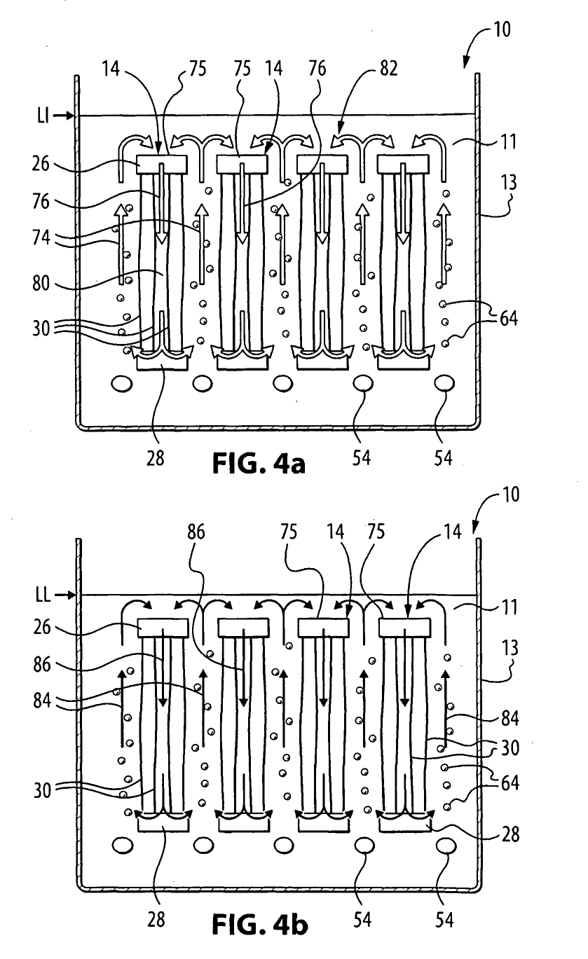

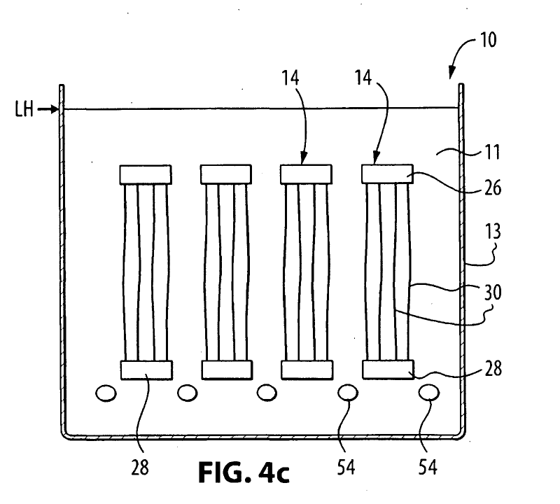

At the intermediate level LI, shown in FIG. 4a, the water pressure in the tank 13 at the aerators 54 is sufficiently low so as to permit the introduction of bubbles 64 into the tank 13 from the aerators 54. The flow rate of gas leaving the aerators 54 into the tank 13 is QLI. As a result of the flow of bubbles 64 from the aerators 54, an air-lift effect is created, which creates a generally upwards flow of water 11 in the vicinity of the flows of bubbles 64. The regions of the tank 13 in which there is an upward flow of water 11 are shown at 74, (and may also be referred to as upward flow regions 74). In turn, water 11 reaching the tops of the upward flow regions 74 flows laterally away from the tops of the upward flow regions 74. The amount of lateral flow of water 11 that is generated is at least partially dependent on the height of the water level above the tops of the membrane modules 14. The tops of the membrane modules 14 are shown at 75. At other regions of the tank 13 a downward flow of water 11 is generated to offset the upward flow of water 11 in the upward flow regions 74, thereby creating a circulation pattern in the water 11. Such regions of downward flow (also referred to as downward flow regions) are shown at 76 and may be present anywhere suitable, and may differ in location depending on such factors as the sizes and positions of the membrane modules 14, the configuration of the tank 13, the positions of the aerators 54, and the gas flow rate. For example, downward flow regions 76 may be present in regions 80 of the tank 13 between the regions 74 of bubble flow.

The downward flow regions 76 that are generated in turn urge a higher flow rate of water 11 upwards in the upward flow regions 74. Thus, a circulation pattern is set up which can reach equilibrium at some pseudo-steady state condition. The circulation pattern is shown generally at 82.

The circulation pattern 82 is useful to urge the mixing of the water 11 in the tank 13, so as to inhibit the buildup of water 11 with a high concentration of solids in the vicinity of the membranes 30 as pure water passes through the membranes 30.

In general, the flow of bubbles 64 near the membranes 30 creates stresses on the membranes 30 and on their connections to the upper and lower permeate headers 26 and 28. A relatively greater bubble flow rate creates relatively greater stresses on the membranes 30 and on their connections to the permeate headers 26 and 28. It is optionally possible to select an intermediate water level LI that keeps the bubble flow rate QLI relatively low since there is relatively inefficient cleaning taking place relative to the stresses generated on the membranes 30 and on their connections, while ensuring that QLI is sufficiently high to generate the desired circulation pattern.

Thus, it is preferable to select an intermediate water level LI that permits a relatively low intermediate gas flow rate QLI from the aerators 54, so as to reduce the energy wastage associated with the gas supply device 58, while still permitting sufficient gas flow to create a sufficient circulation pattern 82 to achieve the aforementioned mixing of the water 11.

In general, the circulation pattern 82 has a detrimental effect on the residence time of the bubbles 64 in the tank 13. In other words, the circulation pattern 82 itself causes the bubbles 64 to rise more quickly than they would if no circulation pattern were present. As a result of the reduced residence time, the effectiveness of the flow of bubbles 64 at cleaning and/or inhibiting the fouling of the membranes 30 is reduced. Thus, there is a tendency for there to be a strong water circulation pattern in the presence of a high gas flow rate into the tank 13. It is desirable to provide a means for de-coupling the presence of a strong water circulation pattern from the presence of a high gas flow rate so that, for example, a high gas flow can be provided without generating a strong water circulation pattern.

At the low water level LL, shown in FIG. 4b, the water pressure that resists the introduction of bubbles 64 into the tank 13 from the aerators 54 is relatively lower, as compared to the water pressure at the intermediate water level, and so gas leaves the aerators 54 into the tank 13 at a relatively high rate QLL. As a result of the gas flow out of the aerators 54, an air-lift effect is generated and water 11 is urged upwards with the bubbles 64 and so regions of upward water flow (also called upward flow regions) are created, which are shown at 84. The low water level LL is selected, however, to be sufficiently low that there is insufficient room above the membrane modules 14 to permit a significant lateral flow of water 11 away from the tops of the upward flow regions. As a result of the relatively low lateral flow of water 11, backpressure is created at the tops of the upward flow regions 84 limiting the overall upward flow rate of water 11 in those regions 84, relative to periods when the water level is at the intermediate level LI (FIG. 4a) and is therefore higher above the tops 75 of the membrane modules 14.

As a result of the reduced lateral flow of water 11 at the tops of the upward flow regions 84 when the water level is at the low water level LL (FIG. 4b), the corresponding regions of downward flow, shown at 85 have a reduced flow rate associated therewith and so the overall degree of circulation that is generated is reduced, as compared with periods when the water level is at the intermediate level LI (FIG. 4a). As a result of the reduced circulation (which is intended to encompass a condition where there is no circulation), the residence time of the bubbles 64 in the water 11 is relatively higher than it is for bubbles 64 when the water level is at the intermediate level LI.

It is possible for the principal distinction between the low and intermediate water levels to be the presence of a weak or strong circulation pattern in the water 11. In other words, the gas flow rate from the aerators 54 at the intermediate water level may be similar to the gas flow rate from the aerators 54 at the low water level, with the principal distinction between the two being that there is little or no circulation taking place at the low water level and a stronger circulation taking place at the intermediate water level.

At the high water level LH, shown in FIG. 4c, the water pressure at the aerators 54 is sufficiently high to substantially stop the flow of gas from the aerators 54. The flow rate of gas leaving the aerators 54 when the water level is at the high level LH is QLH, which is preferably approximately zero.

If the water level is held at the high water level LH for too long, the membranes 30 will foul irreversibly. However, if the water level is reduced to the intermediate or low levels LI (FIG. 4a) or LL (FIG. 4b) after a sufficiently short period of time, bubbles 64 (FIGS. 4a and 4b) are generated which can clean the membranes 30 to offset the fouling that takes place at the high water level LH.

The high water level LH may be selected to be sufficiently high to cause the water pressure surrounding the aerators to be sufficiently high to cause water 11 from the tank 13 to enter the interiors of the aerators 54. The aerator interiors are shown at 86. When water 11 enters the aerator interiors 86, it will enter through both the aeration apertures 62 (FIG. 3) on the upper surface 65, and possibly through the purge apertures 66 on the underside 68. After a selected period of time, the water level is reduced to either the intermediate level LI (FIG. 4a) or the low level LL (FIG. 4b), which reduces the water pressure surrounding the aerators 54, which in turn permits the gas pressure in the aerators 54 (which has potentially remained generally constant) to overcome the now-lower water pressure and thereby push the water 11 in the aerators 54 out back into the tank 13. The water 11 thus leaves the aerators 54 and reenters the tank 13 through the purge apertures 66. Thus, by controlling the water pressure outside the aerators 54, the water 11 enters and leaves the aerators 54 to clean them.

The action of water 11 (FIG. 4c) passing through the aerator interiors 86 and out through the purge apertures 66 serves to at least partially clean the interiors 86 of solids that accumulate therein. The action of the water 11 (FIG. 4c) passing through the aeration apertures 62 serves to at least partially remove any solids that accumulate on the edges of the aeration apertures 62. Any solids on the edges of the aeration apertures 62 can alter the bubble size of bubbles 64 that are emitted therefrom, which can impact the cleaning/fouling inhibition performance of the bubbles 64.

It will be understood that the action of water 11 moving into and out of the aerators 54 is sufficient to clean them at least partially and therefore has some advantage even if the aerators 54 do not completely purge themselves of water 11 when the water level in the tank 13 is reduced, ie even if some water remains for whatever reason in the aerators 54 after the water level has been reduced.

Referring to FIG. 1, it will be noted that, in embodiments wherein the gas supply device 58 is a blower, it may operate at substantially the same rotational speed at all of the low, intermediate and high water levels, LL, LI and LH (FIGS. 4b, 4a and 4c respectively). It is optionally possible that the gas supply device 58 would have a ‘constant-flow’ configuration, wherein it would increase its rotational speed in the event of increased back pressure (eg. as a result of an increase in the water level in the tank 13) and would decrease its rotational speed in the event of a reduced back pressure (eg. as a result of a decrease in the water level in the tank 13).

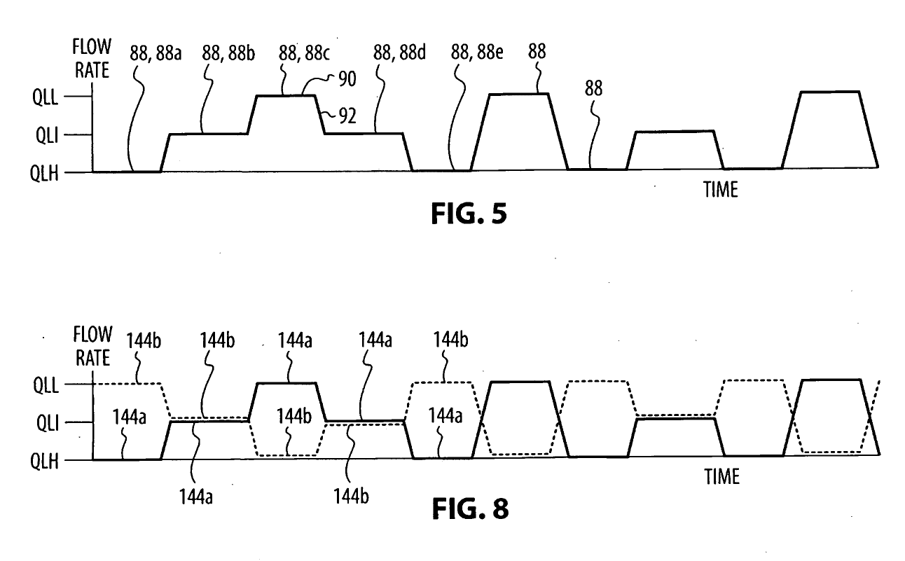

During operation of the membrane filtration system 10, the water level may be adjusted between the low, intermediate and high levels LL, LI and LH (FIG. 4b, 4a and 4c respectively) in successive stages, thereby adjusting the gas flow rate leaving the aerators 54 between the QLL, QLI and QLH flow rates. FIG. 5 is a graph showing the successive stages in terms of gas flow rate versus time. The stages 88 may follow a repeating pattern, or they may optionally not follow a repeating pattern. The stages 88 each include a ramping period 90 and a holding period 92.

For any stages 88 wherein the water level is held at the high level LH, the holding period 92 is to be less than about 15 seconds for certain types of installation so as to prevent the membranes 30 (FIG. 1) from becoming irreversibly fouled, however it will be understood that this limit can vary depending on any of several factors, such as the concentration of solids 12 in the water 11 and the depth of the tank 13.

At any stages 88 wherein the water level is held at the intermediate or low levets LI (FIG. 4a) or LL (FIG. 4b), the holding period 92 is preferably less than about 30 seconds and more preferably less than about 20 seconds, so as to inhibit the occurrence of channeling. Channeling is a flow condition wherein substantially all of the bubbles 64 flow upwards along a path of low resistance, thereby avoiding contact with the membranes 30. The path may be, for example, in the space between adjacent membrane modules 14. As a result, when a channeling condition arises, the cleaning efficiency of the bubbles 64 drops. The time required for a channeling condition to occur varies depending on the specific details of the installation, such as, for example, the geometry of the membrane filtration system 10.

The successive stages 88 shown in FIG. 5 include a first stage 88a at QLH, a second stage 88b at QLI, a third stage 88c at QLL, a fourth stage 88d at QLI, a fifth stage 88e at QLH, a sixth stage at QLL and so on. It will be noted that any grouping of four successive stages 88 in the graph shown in FIG. 5 includes stages 88 at all three gas flow rates QLH, QLI and QLL. This further inhibits the formation of channeling, relative to embodiments wherein the gas/bubble flow rates are changed back and forth between different flow rates.

The ramping periods 94 that are part of each stage 88 are preferably relatively short (eg. less than about five seconds) so that the function achieved at each successive stage 88 (eg. cleaning of aerators, circulation of water 11 in the tank 13, or aeration of membranes 30) can take place at the relatively quickly after a previous holding period 90 is completed.

In the event that a repeating pattern, ie. a cycle, is established using the membrane filtration system 10, it is preferable that the cycle not repeat itself for at least 120 seconds. It is also possible to operate the membrane filtration system 10 with a progression of successive stages 88 that never form a consistently repeating pattern.

In one embodiment, a cycle may include a set of five successive stages 88, such as the stages 88a, 88b, 88c, 88d and 88e. In other words, a cycle could include five successive stages 88, including the first stage 88a wherein the gas flow rate is approximately zero, the second stage 88b wherein the gas flow rate is a value QLI, which is preferably relatively low and non-zero, and wherein a circulation pattern is generated, the third stage 88c wherein the gas flow rate is relatively high and wherein there is little or no circulation pattern present in the water 11, a fourth stage 88d wherein the gas flow rate is the value QLI again and wherein the circulation pattern is generated, and a fifth stage 88e, wherein the gas flow rate is approximately zero. It will be understood, that the cycle could optionally include a sixth stage and more, while still containing the five successive stages 88a, 88b, 88c, 88d and 88e.

The functions described above for each of the water levels LH, LI and LL are exemplary functions only. Other functions may be served at each water level. For example, the low, intermediate and/or high water levels may be selected at least in part to control the size of bubbles 64 that leave the aerators 54 into the tank 13. Controlling the size of the bubbles 64 impacts the type of work done by the bubbles 64, as is known in the art. Thus, the progression of successive stages 88 could be performed to control the bubble size.

As an alternative to controlling the water level between three levels (ie. low, intermediate and high levels), it is possible for the membrane filtration system 10 to control the water level between two levels, such as, for example, a first relatively lower level, (which may be similar to the low water level), wherein a high gas flow from the aerators 54 is achieved without a strong circulation pattern present in the water 11, and a second, relatively higher level, (which may be similar to the intermediate level), where there is a relatively strong circulation pattern present in the water 11 but wherein the gas flow from the aerators 54 may be relatively lower.

In order to achieve the changes in water level described above, any one or more of the control valves 44 and 51, the diverter valve 53, the pumps 48 and 52 may be adjusted. Such adjustments are preferably made automatically by the control system 24. For example, adjustments can be made to the following to control the water level in the tank 13: the flow of feedwater 40 and/or concentrate 49 into the tank 13; the flow of concentrate 49 out of the tank 13; and the rate of permeate collection through the membranes 30.

It will be understood that not all of these components are necessary for proper functioning of the membrane filtration system 10. For example, the control valve 51 may optionally be removed and the pump 52 may be relied upon to control the flow of concentrate 49 out of the tank 13.

It is possible for the membrane filtration system 10 to include other tanks 13 all operated in parallel from the same gas supply device 58, wherein their water levels are maintained at similar levels.

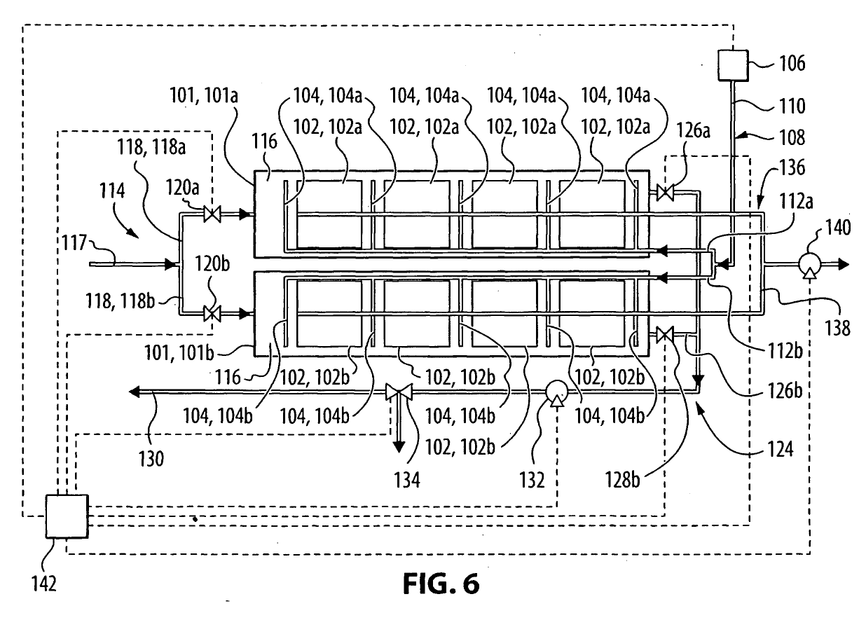

Reference is made to FIG. 6, which shows a schematic plan view of a membrane filtration system 100 in accordance with another embodiment of the present invention. The membrane filtration system 100 includes two tanks 101, including a first tank shown at 101a and a second tank shown at 101b. In each tank 101 are one or more membrane modules 102. The membrane modules in the first tank 101a are shown at 102a. The membrane modules in the second tank 101b are shown at 102b. It will be understood that there could be more or fewer membrane modules 102 in each of the tanks 101a and 101b. It is preferable that there be the same number of membrane modules 102 in each tank 101.

An aerator system 103 is provided, and includes one or more aerators 104 in each tank 101, a common gas supply device 106 and an aerator system conduit system 108. In the embodiment shown in FIG. 6, there are four first aerators 104a in the first tank 101a and four second aerators 104b in the second tank 101b. The aerators 104a and 104b are all connected to the common gas supply device 106 via the aerator system conduit system 108. The aerators 104 themselves may be similar to the aerators 54. The gas supply device 106 may be similar to the gas supply device 58.

The aerator system conduit system 108 includes a main supply conduit 110 from the gas supply device 106, which splits into two aeration headers 112a and 112b, which, in turn feed the aerators 104a and 104b respectively.

There is provided a feedwater supply system 114, which supplies water 116 to the tanks 101a and 101b. The feedwater supply system 114 may include a main feedwater conduit 117, which branches into an individual feedwater conduit 118 for each tank 101. Thus, there is a feedwater conduit 118a supplying feedwater to the tank 101a and a feedwater conduit 118b for supplying feedwater to the tank 101b. The feedwater conduits 118a and 118b have feedwater control valves 120a and 120b respectively thereon for controlling the flow of feedwater into the tanks 101a and 101b respectively.

There is also provided a drain system 124, which includes individual drain conduits 126a and 126b leaving the tanks 101a and 101b respectively. The drain system 124 further includes control valves 128a and 128b on the drain conduits 126a and 126b respectively for providing individual control of the draining of concentrate from the tanks 101a and 101b. The drain conduits 126a and 126b combine into a common drain header 130, in which there is mounted a drain system pump 132 and a drain system diverter valve 134. The drain system diverter valve 134 controls the flow of concentrate either out of the system 100 or back to the feedwater supply conduit 117. Instead of sending concentrate back to the feedwater supply conduit 117, the common drain header 130 could send concentrate back into the tanks 101a and 101b separately from the feedwater supply system 114.

There is further provided a permeate collection system 136 which includes the permeate collection conduit system 138 and a permeate collection pump 140, which draws permeate from the membrane modules 102a and 102b.

The control system, shown at 142 preferably controls all of the control valves 120a, 120b, 128a and 128b, the diverter valve 134, the pumps 132 and 140, and the gas supply device 106.

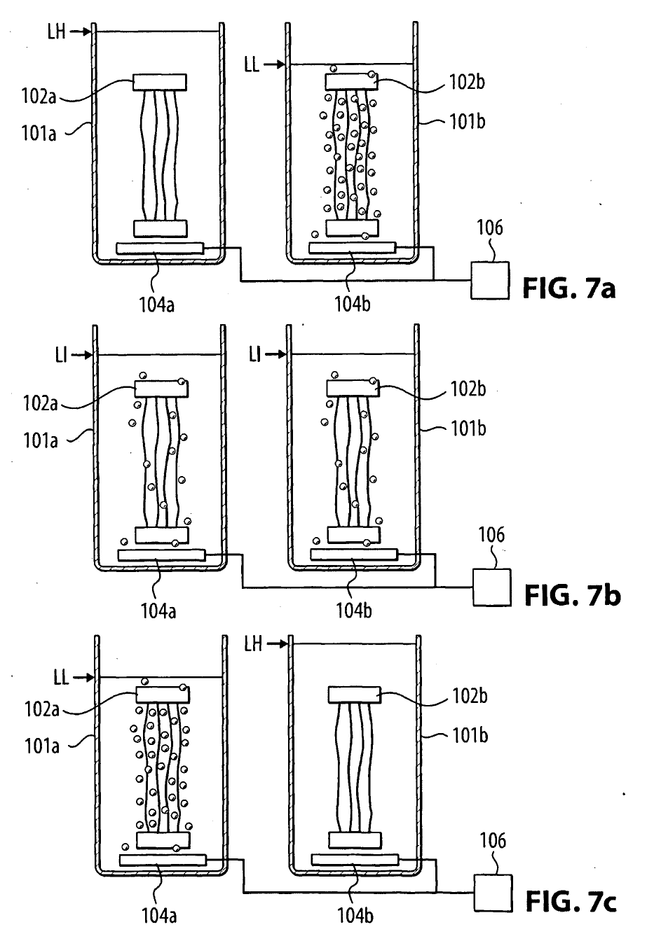

In similar manner to the membrane filtration system 10 shown in FIG. 1, the water level in each of the tanks 101a and 101b may be controlled between three levels as shown in FIGS. 7a, 7b and 7c. FIG. 7a shows a first state wherein the first tank 101a is at the high water level LH, and the second tank 101b is at the low water level LL. In this first state, the gas flow rate leaving the aerators 104a into the tank 101a is QLH which is approximately zero, and the gas flow rate leaving the aerators 104b into the tank 101b is QLL which is relatively high. Because the water level is low in the tank 101b, there is relatively little circulation taking place therein. In the state shown in FIG. 7a, the gas provided by the gas supply device 106 is substantially entirely being delivered to the second tank 101b.

FIG. 7b shows a second state wherein the first tank 101a is at the intermediate water level LI, and the second tank 101b is also at the intermediate water level LI. In this second state, the gas flow rates leaving the aerators 104a and the aerators 104b into the respective tank 101a and 101b is QLI, which may be relatively low. Because the water level is sufficiently high in each of the tanks 101a and 101b, there is circulation taking place in the tanks 101a and 101b. In the state shown in FIG. 7b, the gas provided by the gas supply device 106 is being delivered relatively evenly to both the first and the second tanks 101a and 101b.

FIG. 7c shows a third state which is essentially the reverse of the state shown in FIG. 7a. In the third state the first tank 101a is at the low water level LL, and the second tank 101b is at the high water level LH. In this third state, the gas flow rate leaving the aerators 104a into the tank 101a is QLL which is relatively high, and the gas flow rate leaving the aerators 104b into the tank 101b is QLH which is approximately zero. Because the water level is low in the tank 101a, there is relatively little circulation taking place therein. In the state shown in FIG. 7c, the gas provided by the gas supply device 106 is substantially entirely being delivered to the first tank 101a.

The control system 142 may be configured to operate the various control valves, diverter valve, pumps and gas supply device so that the membrane filtration system 100 incurs successive stages of the three states shown in FIGS. 7a, 7b and 7c. An example of the progressions of successive stages 144a and 144b for both tanks 101a and 101b is shown in FIG. 8, which is a graph of the gas flow rates for each of the tanks 101a and 101b over time. It can be seen from FIG. 8, that the overall gas consumption, which is the sum of the gas flow rates for both tanks 101a and 101b at any point in time, never exceeds a selected value, which may be approximately the value of QLL, since the value of QLH is preferably approximately zero and since the value of QLI may be selected to be relatively low (ie. less than ½ the value of QLL). Because the progression of successive stages 144a of gas flow in the tank 101a and the progression of successive stages 144b of gas flow in the tank 101b are mirror images of each other, the instantaneous gas flow consumed by the two tanks 101a and 101b at any given point in time is relatively low. This permits the selection of a relatively smaller gas supply device 106 (eg. blower), which reduces the overall energy consumed by the gas supply device 106 during operation. By virtue of operating the two tanks 101a and 101b on mirror image progressions of successive stages will be understood that the overall energy consumed is lower (potentially significantly lower) than the energy that would be consumed if the two tanks 101a and 101b were operated by two independent gas supply devices.

It will be observed that the highest aeration gas flow rate is supplied to one of the tanks 101 when there is little or no air-lift induced water circulation pattern in that tank 101, and a lower gas flow rate is supplied to that tank 101 when there is an air-lift induced water circulation pattern. The gas flow generated by the gas supply device 106 is not wasted however; what isn't supplied to that tank 101 is supplied to another tank 101 that has little or no air-lift induced water circulation pattern. In other words, a significant portion of the gas flow generated by the gas supply device is released into tanks 101 when the residence time of the bubbles would be relatively high. This reduces the overall gas flow required to acheive a given level of cleaning performance, thereby lowering the costs of operation of the membrane filtration system compared to some other systems, in addition to the other advantages noted above in respect of the membrane filtration system 10 shown in FIG. 1, such as the reduction of stresses on the membranes and their connections to the permeate headers.

It will be noted that cycling of gas flow from a single gas supply device 106 between two (or more) tanks 101 is achieved without the need for valves on the aeration headers 112a and 112b.

Exemplary progressions of successive stages of gas flow have been illustrated in FIGS. 5 and 8. It will be understood that there could be other progressions of successive stages of gas flow that would also be suitable.

It will be understood that the number of tanks, the number of membrane modules per tank, and the number of aerators per membrane module and per tank shown and described in the embodiments above is exemplary only and that other quantities of tanks, membrane modules and aerators may be provided. Additionally, while an exemplary embodiment has been shown with a single gas supply device feeding two tanks with different progressions of gas flow, it is optionally possible for a single gas supply device to be fluidically connected to three or more tanks each with a different progression of gas flow.

In the embodiments shown and described the membranes have fed permeate into two permeate headers (eg. headers 26 and 28 in FIG. 1). It is alternatively possible for the membranes to be closed at one end and to feed permeate only into a single header, such as the lower header 28. This alternative is also applicable to embodiments wherein a single gas supply device feeds two or more tanks containing membrane modules, such as the embodiment shown in FIG. 6.

While the above description constitutes a plurality of embodiments of the present invention, it will be appreciated that the present invention is susceptible to further modification and change without departing from the fair meaning of the accompanying claims.

I claim:

1. A method of aerating at least one membrane module immersed in water in a tank, comprising:
providing a flow of gas to at least one aerator to produce a flow of bubbles in the tank for cleaning or inhibiting fouling of the at least one membrane module; and
adjusting the level of the water in the tank to control the flow of bubbles from the at least one aerator.

2. A method as claimed in claim 1, wherein the step of adjusting the level of the water includes a repeating cycle including adjusting the level of the water to a high level to reduce the flow rate of gas leaving the at least one aerator as bubbles, and adjusting the level of the water to a low level to increase the flow rate of gas leaving the at least one aerator as bubbles.

3. A method as claimed in claim 2, wherein the high level of the water is sufficiently high to substantially stop the flow of gas from the at least one aerator.

4. A method as claimed in claim 1, wherein the water level in the tank is adjusted to control the size of bubbles from the at least one aerator.

5. A method as claimed in claim 1, wherein the water level in the tank is adjusted to control the flow rate of gas leaving the at least one aerator as bubbles.

6. A method as claimed in claim 1, wherein the water level in the tank is adjusted to control both the size of bubbles from the at least one aerator and the flow rate of gas leaving the at least one aerator as bubbles.

7. A method as claimed in claim 1, wherein the water level in the tank is adjusted to control the circulation of water in the tank.

8. A method as claimed in claim 2, wherein the low level is sufficiently low to inhibit the circulation of water in the tank.

9. A method as claimed in claim 2, wherein the high level is sufficiently high to permit circulation of water in the tank arising from bubbles leaving the at least one aerator.

10. A method as claimed in claim 8, wherein the water level is held at the low level for a sufficiently long period of time to permit the movement of water in the tank to substantially reach a pseudo steady state condition.

11. A method as claimed in claim 9, wherein the water level is held at the high level for a sufficiently long period of time to permit the movement of water in the tank to substantially reach a pseudo steady state condition.

12. A system for aerating at least one membrane module immersed in water in a tank, comprising:
at least one aerator positioned for releasing gas bubbles into the water to clean or inhibit fouling of the at least one membrane module;
a feedwater conduit for introducing water to the tank;
a drain conduit for removing water from the tank;
a control valve positioned to control the flow of water through at least one of the feedwater conduit and the drain conduit; and
a control system operatively connected to the control valve, wherein the control system is configured to control the control valve to adjust the level of the water in the tank to control at least one of: the flow of bubbles in the tank, the circulation of water in the tank, and the level of water in the at least one aerator.

13. A system as claimed in claim 12, wherein the control system is configured to control the water level in the tank based on a set of parameters including: the flow rate of water into the tank, the production rate of permeate through the at least one membrane module, and the flow rate of water through the drain conduit.

14. A method as claimed in claim 12, wherein the control system is configured to control the water level in the tank between a high level to reduce the flow rate of gas leaving the at least one aerator as bubbles, and a low level to increase the flow rate of gas leaving the at least one aerator as bubbles.

15. A method of aerating at least one membrane module immersed in water in a tank, comprising:
providing a flow of gas to at least one aerator to produce a flow of bubbles in the tank for cleaning or inhibiting fouling of the at least one membrane module; and
controlling the water level in the tank between a high water level and a low water level to control the degree of circulation of water in the tank resulting from the flow of bubbles leaving the at least one aerator.

16. A method as claimed in claim 15, further comprising:
controlling the flow of gas leaving the at least one aerator as bubbles in the tank between a high flow rate and a low flow rate.

17. A method as claimed in claim 16, wherein the gas flow is controlled at least in part by the water level so that when the water level is at the high water level the flow of gas leaving the at least one aerator is at a low flow rate, and when the water level is at the low water level the flow of gas is at a high flow rate.

18. A method as claimed in claim 15, wherein, over at least a portion of the range of water levels between the high water level and the low water level, the control of the flow of gas leaving the at least one aerator is independent from the control of the water level.

19. A method as claimed in claim 15, wherein, over at least a portion of the range of water levels between the high water level and the low water level, the flow of gas leaving the at least one aerator is independent of the water level.

20. A method as claimed in claim 15, wherein, over at least a portion of the range of water levels between the high water level and the low water level, the flow of gas leaving the at least one aerator is generally constant.

21. A method of aerating a first membrane module immersed in water in a first tank and a second membrane module in a second tank, comprising:
providing a first aerator to produce bubbles in the first tank for cleaning or inhibiting fouling of the first membrane module;
providing a second aerator to produce bubbles in the second tank for cleaning or inhibiting fouling of the second membrane module;
fluidically connecting the first and second aerators to a common gas source;
controlling the water level in each of the first and second tanks between a high water level and a low water level, in a cycle including a first stage wherein the water level in the first tank is at the high water level and the water level in the second tank is at the low water level so that backpressure in the first aerator urges gas flow from the common source to preferentially travel to the second aerator, and a second stage wherein the water level in the first tank is at the low water level and the water level in the second tank is at the high water level so that backpressure in the second aerator urges gas flow from the common source to preferentially travel to the first aerator.

22. A system for aerating a first membrane module immersed in water in a first tank and a second membrane module in a second tank, comprising:
a first aerator positioned to produce bubbles in the first tank for cleaning or inhibiting fouling of the first membrane module;
a second aerator positioned to produce bubbles in the second tank for cleaning or inhibiting fouling of the second membrane module;
a common gas source fluidically connected to the first and second aerators; and
a control system for controlling the water level in the first and second tanks, wherein the control system is configured to hold the water level in each of the tanks in successive stages including a first stage wherein the water level in the first tank is at the high water level and the water level in the second tank is at the low water level so that backpressure in the first aerator urges gas flow from the common source to preferentially travel to the second aerator, and a second stage wherein the water level in the first tank is at the low water level and the water level in the second tank is at the high water level so that backpressure in the second aerator urges gas flow from the common source to preferentially travel to the first aerator.

23. A system as claimed in claim 22, wherein a plurality of first membrane modules are positioned in the first tank and a plurality of second membrane modules are positioned in the second tank.

24. A method of aerating at least one membrane module immersed in water in a tank, comprising:
providing a flow of gas to at least one aerator to produce a flow of bubbles in the tank for cleaning or inhibiting fouling of the at least one membrane module; and
controlling the water level in the tank between a high water level, an intermediate water level and a low water level to control the degree of circulation of water in the tank and to control the flow of bubbles from the at least one aerator,
wherein at the low water level, the flow rate of gas leaving the at least one aerator is a first flow rate and circulation in the tank is inhibited as a result of the low water level,
and wherein at the high water level the flow rate of gas leaving the at least one aerator is a second flow rate that is lower than the first flow rate and circulation in the tank is permitted as a result of the high water level,
and wherein at the intermediate water level, the flow rate of gas leaving the at least one aerator is a third flow rate that is not lower than the second flow rate and not higher than the first flow rate and circulation in the tank is permitted as a result of the intermediate water level.

25. A method as claimed in claim 24, wherein the second flow rate is approximately zero.

26. A method as claimed in claim 25, wherein the third flow rate is closer to the second flow rate than to the first flow rate.

27. A method as claimed in claim 24, wherein the water level in the tank is adjusted between the high, intermediate and low levels in a cycle, the cycle comprising successive stages of holding the water level at one of the high, intermediate and low water levels for a period of less than about 20 seconds, adjusting the water level to another of the high, intermediate and low water levels over a period of less than about 5 seconds, wherein the water level is not held at the high water level for longer than about 15 seconds, and wherein over any four successive stages the water level has been held at the each of the low, intermediate and high water levels at least once.

28. A method as claimed in claim 24, wherein the water level in the tank is adjusted between the high, intermediate and low levels in a cycle, the cycle comprising successive stages of holding the water level at one of the high, intermediate and low water levels for a period of less than about 20 seconds, adjusting the water level to another of the high, intermediate and low water levels over a period of less than about 5 seconds, wherein the water level is not held at the high water level for longer than about 15 seconds, and wherein the cycle includes a first stage at a low water level, a second stage immediately after the first stage at an intermediate water level, a third stage immediately after the second stage at a high water level, a fourth stage immediately after the third stage at an intermediate water level and a fifth stage immediately after the fourth stage at a low water level, and wherein over any four successive stages the water level has been held at the each of the low, intermediate and high water levels at least once.

29. A method as claimed in claim 24, wherein the time period to complete one cycle is greater than 120 seconds.

30. A method of cleaning or inhibiting fouling of an aerator that is immersed in water in a tank for aerating at least one membrane module, comprising:
controlling the pressure in the water in the tank at surrounding the at least one aerator between a high pressure and a lower pressure, wherein at the higher pressure, the at least one aerator fills at least partially with water, and wherein at the lower pressure, gas pressure in the at least one aerator empties the at least one aerator at least partially of water.

31. A method of cleaning or inhibiting fouling of an aerator that is immersed in water in a tank for aerating at least one membrane module, comprising:
controlling the water level in the tank between a high water level and a low water level, wherein at the high water level, the at least one aerator fills at least partially with water, and wherein at the low water level, gas pressure in the at least one aerator empties at least partially of water.

32. A system for aerating at least one membrane module immersed in water in a tank, comprising:
at least one aerator positioned for releasing gas bubbles into the water to clean or inhibit fouling of the at least one membrane module;
a feedwater conduit for introducing water to the tank;
a drain conduit for removing water from the tank;
a control valve positioned to control the flow of water through at least one of the feedwater conduit and the drain conduit; and
a control system operatively connected to the control valve, wherein the control system is configured to control the control valve to adjust the level of the water in the tank to control the water pressure outside the aerator, thereby controlling the flow of water into and out of the aerator
